(19) United States
(12) Patent Application Publication
(10) Pub. No.: US 2026/0312312 A1
(43) Pub. Date: Oct. 8, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yicheng CHEN, Mie (JP); Teruo HARA, Mie (JP)

(21) Appl. No.: 19/482,785

(22) PCT Filed: May 15, 2024
(86) PCT No.: PCT/JP2024/018029

§ 371 Date: Nov. 10, 2025

(30) Foreign Application Priority Data
May 16, 2023 (JP) 2023-080535

(51) Int. Cl. H01R 12/72

(52) U.S. Cl. CPC H01R 12/722

(57) ABSTRACT

A connector includes a housing including a pair of outer wall surfaces located on both end parts in a width direction and formed with a press-fit portion on the outer wall surface, and a peg made of metal, including a fixing portion to be fixed to a circuit board and a plate-like portion arranged to cover the outer wall surface and fixed to the housing by press-fitting a press-fit projection projecting from an outer edge part of the plate-like portion into the press-fit portion. The plate-like portion includes a locking portion located in a region separated from the outer edge part of the plate-like portion and configured to bite into the outer wall surface.

### TECHNICAL FIELD

The present disclosure relates to a connector.

### BACKGROUND

A connector disclosed in Patent Document 1 is provided with a connector housing (hereinafter, also referred to as a housing) to be mounted on a circuit board and fixing brackets (hereinafter, also referred to as pegs) to be fixed to the circuit board by soldering. Press-fit mounting portions, in which press-fit portions (hereinafter, also referred to as press-fit projections) projecting outward from outer side edges of the pegs are press-fit and held, are formed on both side surfaces of the housing.

### PRIOR ART DOCUMENT

### Patent Document

Patent Document 1: JP 2014-049331 A

### SUMMARY OF THE INVENTION

### Problems to be Solved

However, since the pegs are fixed to the housing only by the fitting of the press-fit projections and the press-fit mounting portions, a fixing force to the housing is weak and, for example, the housing may be deformed at the time of reflow and displaced toward the circuit board.

The present disclosure aims to enhance a fixing force of a housing and a peg.

### Means to Solve the Problem

The present disclosure is directed to a connector with a housing having a pair of outer wall surfaces located on both end parts in a width direction, the housing being formed with a press-fit portion on the outer wall surface, and a peg made of metal and including a fixing portion to be fixed to a circuit board and a plate-like portion arranged to cover the outer wall surface, the peg being fixed to the housing by press-fitting a press-fit projection projecting from an outer edge part of the plate-like portion into the press-fit portion, the plate-like portion including a locking portion located in a region separated from the outer edge part of the plate-like portion, the locking portion biting into the outer wall surface.

### Effect of the Invention

According to the present disclosure, it is possible to enhance a fixing force of a housing and a peg.

### BRIEF DESCRIPTION OF THE DRAWINGS

FIG. 1 is a perspective view of a connector of one embodiment.

FIG. 2 is an enlarged perspective view of the connector of the embodiment.

FIG. 3 is a perspective view of a peg provided in the connector of the embodiment.

FIG. 4 is a side view in section of the connector of the embodiment.

FIG. 5 is an enlarged front view in section showing a locking portion of the connector of the embodiment.

FIG. 6 is an enlarged front view in section showing a reinforcing portion of the connector of the embodiment.

FIG. 7 is a perspective view of a terminal fitting provided in the connector of the embodiment.

### DETAILED DESCRIPTION TO EXECUTE THE INVENTION

### Description of Embodiments of Present Disclosure

(1) The connector of the present disclosure is provided with a housing having a pair of outer wall surfaces located on both end parts in a width direction, the housing being formed with a press-fit portion on the outer wall surface, and a peg made of metal and including a fixing portion to be fixed to a circuit board and a plate-like portion arranged to cover the outer wall surface, the peg being fixed to the housing by press-fitting a press-fit projection projecting from an outer edge part of the plate-like portion into the press-fit portion, the plate-like portion including a locking portion located in a region separated from the outer edge part of the plate-like portion, the locking portion biting into the outer wall surface. According to this configuration, the peg is fixed to the housing also by the biting of the locking portion into the outer wall surface in addition to the press-fitting of the press-fit projection into the press-fit portion.
(2) In the connector of (1), the plate-like portion includes a pair of first cut portions extending in a direction intersecting the circuit board at positions separated in a front-rear direction while penetrating in a plate thickness direction and a second cut portion connecting end parts of the pair of first cut portions on a side distant from the circuit board while penetrating in the plate thickness direction, and a part of the plate-like portion defined by the pair of first cut portions and the second cut portion and inclined toward the outer wall surface functions as the locking portion. According to this configuration, since an extending end surface of the locking portion bites into the outer wall surface to support from the circuit board side, a displacement of the housing toward the circuit board at the time of reflow can be prevented.
(3) In the connector of (2), the locking portion has a rectangular shape with the second cut portion as a long side. According to this configuration, as compared to the case where the locking portion has a rectangular shape with the first cut portions serving as long sides, a locking area of the extending end surface of the locking portion to the outer wall surface can be increased, wherefore a displacement of the housing in a direction approaching the circuit board at the time of reflow can be effectively prevented.
(4) In the connector of (3), the press-fit projection includes a first press-fit projection and a second press-fit projection arranged apart from each other in a length direction of the first cut portion on both front and rear side edges of the plate-like portion, and a formation range of the first cut portion is set only in a region between the first and second press-fit projections. According to this configuration, the first and second press-fit projections are arranged at positions shifted in the length direction of the first cut portion from a part of the plate-like portion where a reduction in rigidity is concerned due to the formation of the first and second cut portions. Therefore, the reliability of a fixing force by the press-fitting of the press-fit portion and the press-fit projection is excellent.
(5) In the connector of (4), the plate-like portion includes a pair of reinforcing portions extending outward in the width direction from the both front and rear side edges of the plate-like portion between the first and second press-fit projections. According to this configuration, parts of the plate-like portion between the both front and rear outer side edges and the first cut portions are reinforced by the reinforcing portions. Thus, a reduction in the rigidity of the plate-like portion due to the formation of the pair of first cut portions and the second cut portion can be prevented.
(6) In the connector of (5), the outer wall surface has a first restricting surface facing the reinforcing portions from the fixing portion side. According to this configuration, a relative movement of the peg toward the fixing portion with respect to the housing can be restricted by locking the reinforcing portions to the first restricting surface.
(7) In the connector of (5) or (6), the outer wall surface has a second restricting surface for restricting outward relative displacements of the reinforcing portions in the width direction with respect to the outer wall surface. According to this configuration, an outward relative movement in the width direction of the peg with respect to the housing can be restricted by locking the plate-like portion to the second restricting surface.

### Details of Embodiment of Present Disclosure

An embodiment of the present disclosure is described below with reference to the drawings. The present disclosure is not limited to these illustrations, but is represented by claims and intended to include all changes in the scope of claims and in the meaning and scope of equivalents.

### Embodiment

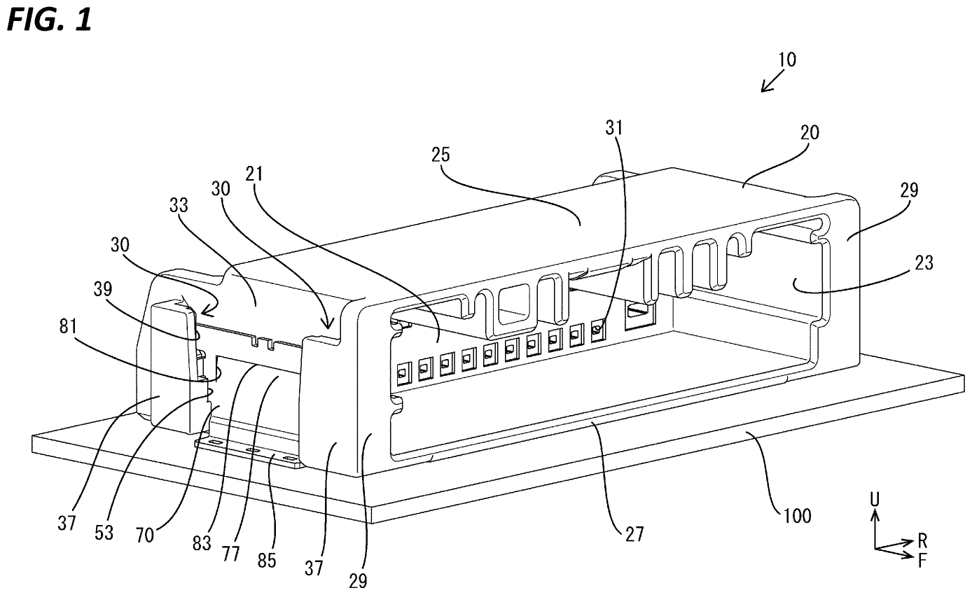

A connector 10 is provided with a housing 20 and pegs 70. In the following description, a “front side” is denoted by “F” in FIGS. 1 to 4 and 7 concerning a front-rear direction. An “upper side” is denoted by “U” in each figure concerning a vertical direction. A “right side” is denoted by “R” in FIGS. 1 to 3 and 5 to 7 concerning a lateral direction. Note that a width direction of the housing is the lateral direction in this embodiment.

### Housing 20

The housing 20 is made of synthetic resin. As shown in FIG. 1, the housing 20 includes a wall portion 21 extending in the width direction and arranged with a plate thickness direction oriented in the front-rear direction and a receptacle 23 in the form of a rectangular tube projecting forward from the outer peripheral edge of the wall portion 21. A mating connector (not shown) is fit into the receptacle 23. The receptacle 23 includes an upper wall 25 and a lower wall 27 arranged at an interval in the vertical direction and a pair of side walls 29 arranged at an interval in the lateral direction. The wall portion 21 includes a plurality of press-fit holes 31, through which terminal fittings 90 to be described later are press-fit.

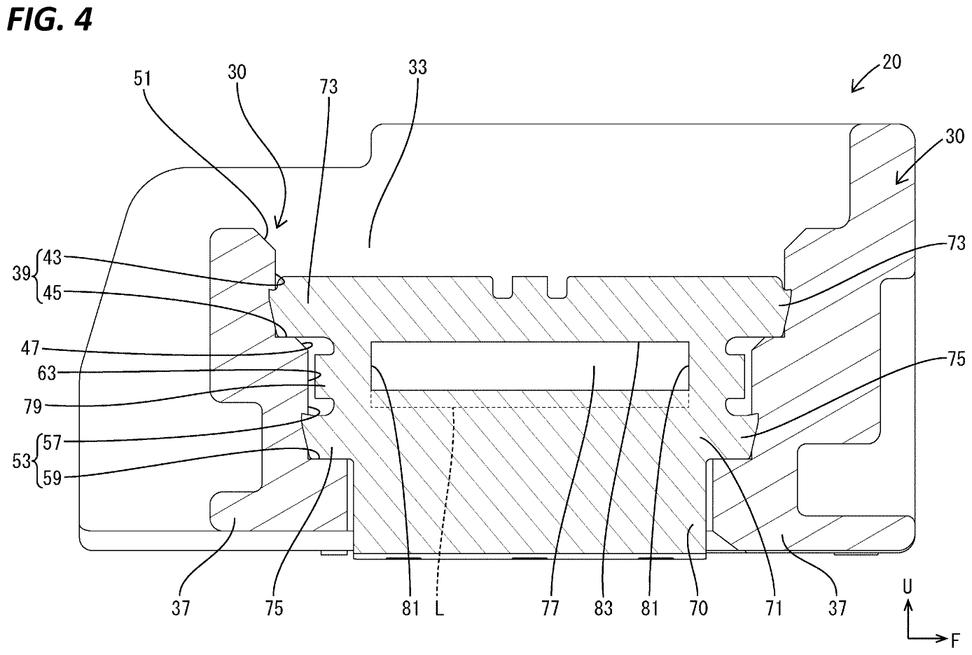

In this embodiment, the outer side surfaces of the pair of side walls 29 formed in the housing 20 are defined as outer wall surfaces 33. The connector 10 includes press-fit portions 30 on the outer wall surfaces 33 of the housing 20. As shown in FIG. 1, the press-fit portion 30 is formed with a first press-fit recess 39 and a second press-fit recess 53. The peg 70 is fixed to the housing 20 by being press-fit into the first and second press-fit recesses 39, 53. As shown in FIG. 4, first press-fit projections 73 of the peg 70 to be described later are press-fit into the first press-fit recesses 39 and second press-fit projections 75 of the peg 70 are press-fit into the second press-fit recesses 53.

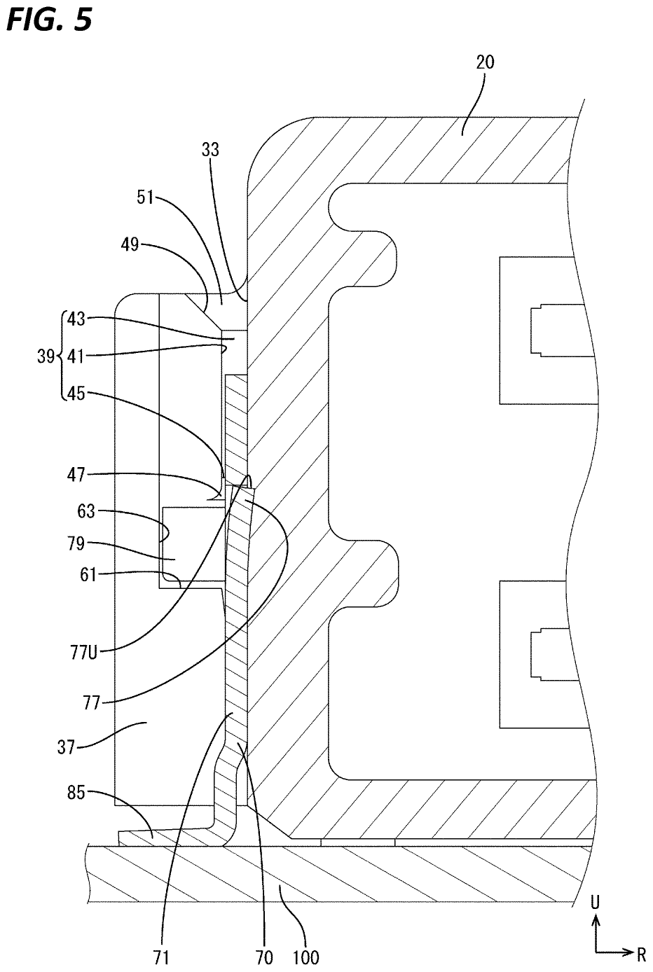

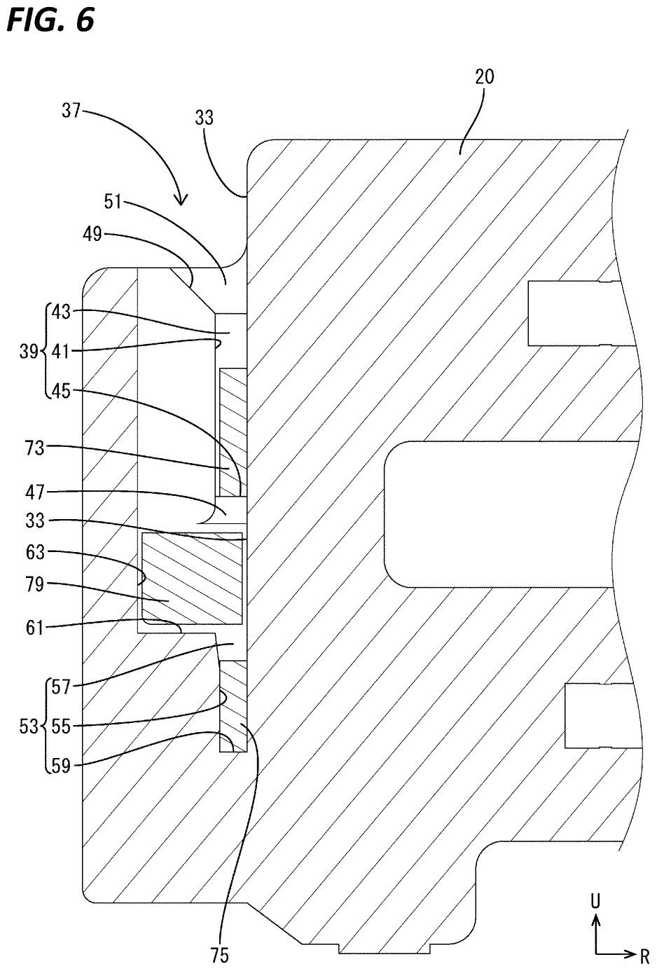

As shown in FIG. 1, the press-fit portions 30 are parts projecting outward in the width direction of the housing 20 from front and rear end parts of each outer wall surface 33. A pair of front and rear press-fit portions 30 are facing each other in the front-rear direction on each outer wall surface 33. A pair of the first press-fit recesses 39 in the form of vertically long slits are formed to face each other in the front-rear direction in upper end parts of the pair of press-fit portions 30. As shown in FIGS. 5 and 6, one first press-fit recess 39 is formed by a first facing wall 41, a first side wall 43 and a first bottom wall 45. The first facing wall 41 is formed to face the outer wall surface 33. In the front and rear end parts of the press-fit portion 30, the first side wall 43 connects the outer wall surface 33 and the first facing wall 41. The first bottom wall 45 forms a bottom part of a space surrounded by the outer wall surface 33, the first facing wall 41 and the first side wall 43. An inclined surface 47 inclined downward toward a center in the front-rear direction of the outer wall surface 33 (with distance from the first side wall 43) is formed on an end part on a central side in the front-rear direction of the outer wall surface 33, out of both front and rear end parts of the first bottom wall 45. Out of both front and rear end parts of the first facing wall 41, the end part on the central side in the front-rear direction of the outer wall surface 33 is curved to spread toward the end part on the central side in the front-rear direction. An upper end part of the first facing wall 41 includes a first tapered portion 49 inclined downward toward a center in the width direction. An upper end part of the first side wall 43 includes a second tapered portion 51 inclined downward toward a center in the front-rear direction. The first press-fit recess 39 is formed in each of the pair of press-fit portions 30.

As shown in FIGS. 4 and 6, the second press-fit recess 53 in the form of a vertically long slit is formed in the front-rear direction in a lower end part of the press-fit portion 30. The second press-fit recess 53 is formed in each of the pair of press-fit portions 30. A pair of the second press-fit recesses 53 are respectively formed below the pair of first press-fit recesses 39. As shown in FIG. 6, the second press-fit recess 53 is formed by a second facing wall 55, second side walls 57 and a second bottom wall 59. The second facing wall 55 is formed to face the outer wall surface 33. A pair of the second side walls 57 connect the outer wall surface 33 and the front end of the second facing wall 55 to each other and the outer wall surface 33 and the rear end of the second facing wall 55 to each other. The second bottom wall 59 forms a bottom part of a space surrounded by the outer wall surface 33, the second facing wall 55 and the second side walls 57. As shown in FIG. 4, the second side walls 57 are formed closer to the central side in the front-rear direction of the outer wall surface 33 than the first side wall 43.

The press-fit portion 30 has a first restricting surface 61. The first restricting surface 61 is connected to the upper end of the second facing wall 55 and extends perpendicularly from the upper end of the second facing wall 55 toward an outer side in the width direction of the housing 20. The first restricting surface 61 is formed in each of the pair of press-fit portions 30. The first restricting surface 61 is arranged to face the lower end of a reinforcing portion 79 to be described later while being spaced apart therefrom in a mounted state of the peg 70. The first restricting surface 61 is formed at a height between the first bottom wall 45 and the second bottom wall 59.

As shown in FIG. 4, the press-fit portion 30 has a second restricting surface 63. The second restricting surface 63 is connected to an outer end part of the first restricting surface 61 in the width direction of the housing 20 and extends perpendicularly upward with respect to the first restricting surface 61. The second restricting surface 63 is formed to face the outer wall surface 33. As shown in FIG. 4, the second restricting surface 63 is formed closer to the central side in the front-rear direction of the housing 20 than the first side wall 43.

### Peg 70

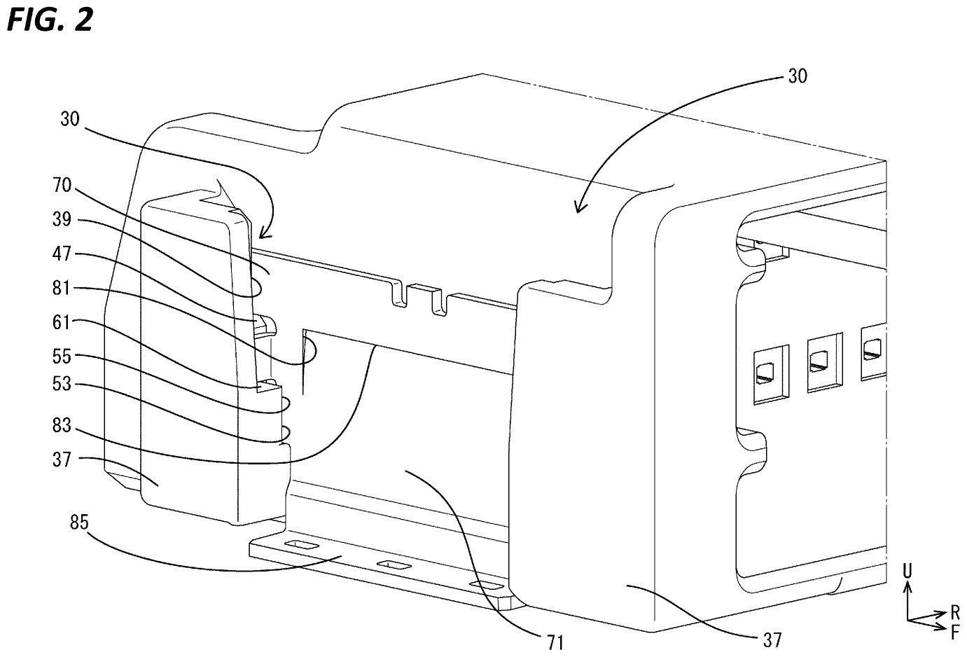

The peg 70 is made of metal. The peg 70 is a single component including a plate-like portion 71 and a fixing portion 85. As shown in FIG. 2, the plate-like portion 71 is mounted on the housing 20 by being press-fit into the press-fit portions 30 and arranged to cover the outer wall surface 33. The fixing portion 85 projects outward in the width direction of the housing 20 from a lower end part of the plate-like portion 71. The fixing portion 85 is fixed to a circuit board 100 by solder.

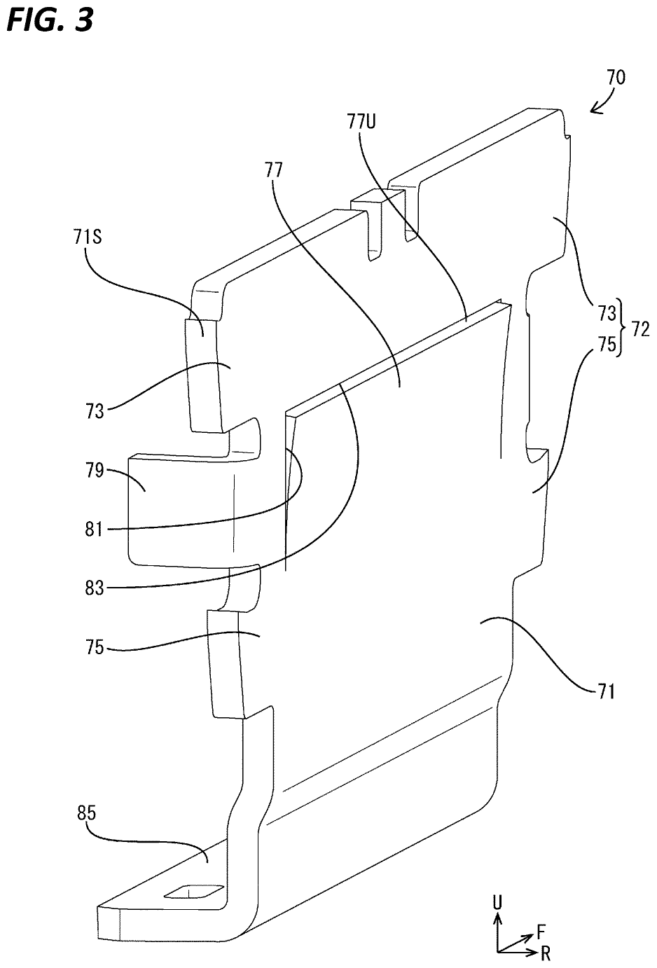

As shown in FIG. 3, the plate-like portion 71 has a flat plate shape and a plate thickness direction thereof is oriented in the lateral direction. The plate-like portion 71 includes a pair of press-fit projections 72, one locking portion 77 and a pair of the reinforcing portions 79. The pair of press-fit projections 72 are composed of a pair of front and rear first press-fit projections 73 and a pair of front and rear second press-fit projections 75. The pair of first press-fit projections 73 are parts projecting from both front and rear outer side edges 71S of the plate-like portion 71 in an upper end part of the plate-like portion 71. As shown in FIG. 4, the pair of first press-fit projections 73 are press-fit in the pair of first press-fit recesses 39. The pair of second press-fit projections 75 are parts projecting from the both front and rear outer side edges 71S in a lower part of the plate-like portion 71. The pair of second press-fit projections 75 are press-fit in the pair of second press-fit recesses 53. The pair of reinforcing portions 79 extend outward in the width direction from the both front and rear outer side edges 71S of the plate-like portion 71 toward the second restricting surfaces 63 perpendicularly to the outer wall surface 33 between the first press-fit projections 73 and the second press-fit projections 75. As shown in FIG. 3, the upper ends of the reinforcing portions 79 are at positions lower than the lower ends of the first press-fit projections 73. The lower ends of the reinforcing portions 79 are at positions higher than the upper ends of the second press-fit projections 75. As shown in FIG. 5, the reinforcing portion 79 is arranged at a position facing the first restricting surface 61 while being spaced apart therefrom right above the first restricting surface 61.

As shown in FIG. 4, the locking portion 77 is formed in the plate-like portion 71. The locking portion 77 is arranged between the lower ends of the first press-fit projections 73 and the upper ends of the second press-fit projections 75 in the vertical direction. The plate-like portion 71 is formed with a pair of front and rear first cut portions 81. The pair of first cut portions 81 penetrate through the plate-like portion 71 in the plate thickness direction and extends in a direction intersecting the circuit board 100 at positions separated in the front-rear direction. The plate-like portion 71 is formed with a second cut portion 83. The second cut portion 83 penetrates through the plate-like portion 71 in the plate thickness direction and extends in the front-rear direction to connect upper end parts of the pair of first cut portions 81. Out of the plate-like portion 71, a part defined by the pair of first cut portions 81 and the second cut portion 83 and inclined toward the outer wall surface 33 functions as the locking portion 77. The pair of first cut portions 81 extend upward in parallel to each other from a height right above the second press-fit projections 75 to a height right below the first press-fit projections 73. As shown in FIG. 4, the locking portion 77 is a rectangular region enclosed by the pair of first cut portions 81, the second cut portion 83 and a line segment L connecting the lower ends of the first cut portions 81, out of the plate-like portion 71. The locking portion 77 projects more toward the housing 20 (toward the outer wall surface 33) than the inner side surface (surface facing the outer wall surface 33) of the plate-like portion 71 by being cut and raised. As shown in FIG. 5, an upper end part of the locking portion 77 projects more toward the housing 20 (toward the outer wall surface 33) than the inner side surface (surface facing the outer wall surface 33) of the plate-like portion 71. The locking portion 77 is in a posture oblique to the plate-like portion 71 and the outer wall surface 33. The locking portion 77 is cantilevered upward by being cut and raised.

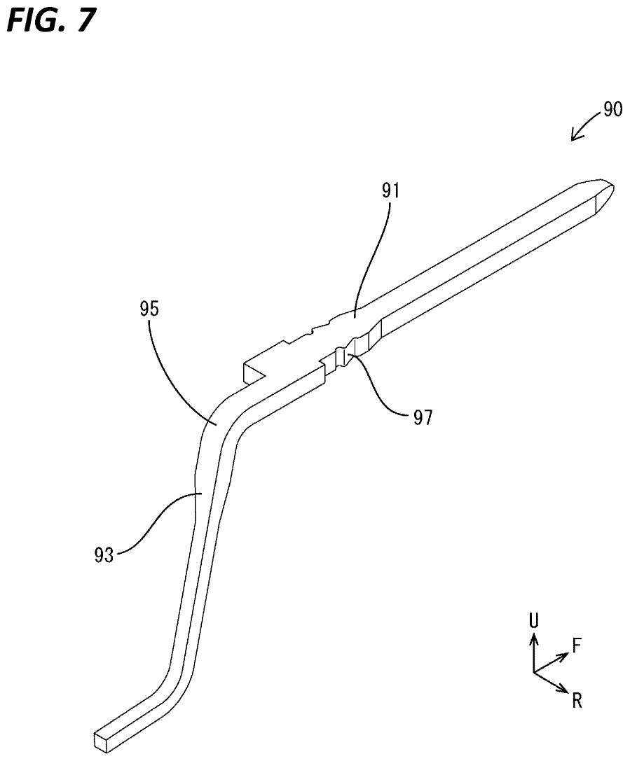

The terminal fitting 90 is press-fit into the housing 20. A front end part of the terminal fitting 90 projects into the receptacle 23. The terminal fitting 90 is made of electrically conductive metal and, as shown in FIG. 7, formed by bending an elongated bar material having a substantially rectangular transverse cross-section substantially at a right angle at two positions. The terminal fitting 90 includes a terminal connecting portion 91 extending straight in the front-rear direction and a board connecting portion 93 connected to the terminal connecting portion 91. A rear end part of the terminal connecting portion 91 is formed with protrusions 97. The board connecting portion 93 is connected to the rear end of the terminal connecting portion 91 via a first bent portion 95 and extends downward from the first bent portion 95. The board connecting portion 93 is bent into an L shape in a side view of the terminal fitting 90. A rear end part of the board connecting portion 93 is connected to the circuit board 100. Gold plating is applied to the surface of the terminal fitting 90 to improve electrical connection to a mating terminal (not shown).

### Functions and Effects of Connector 10

The connector 10 is mounted on the circuit board 100 as described below. First, the terminal fitting 90 is press-fit into each press-fit hole 31 of the housing 20. The terminal fitting 90 is positioned with respect to the housing 20 by causing the protrusions 97 of the terminal fitting 90 to bite into the inner wall of the press-fit hole 31. With the terminal fitting 90 positioned, a front end part of the terminal fitting 90 projects into the receptacle 23.

Subsequently, the pegs 70 are mounted on the housing 20. Specifically, the first press-fit projections 73 of the peg 70 are press-fit into the first press-fit recesses 39 from above. As shown in FIG. 6, since a plate thickness of the first press-fit projection 73 is substantially equal to a lateral width of the first press-fit recess 39, the peg 70 is fixed to the housing 20 by press-fitting the first press-fit projections 73. By the inclined surface 47, the first tapered portion 49 and the second tapered portion 51, the first press-fit recess 39 is so shaped that the first press-fit projection 73 is easily press-fit thereinto.

Simultaneously, the second press-fit projections 75 are press-fit into the second press-fit recesses 53 from above. As shown in FIG. 6, since a plate thickness of the second press-fit projection 75 is substantially equal to a lateral width of the second press-fit recess 53, the peg 70 is fixed to the housing 20 by press-fitting the second press-fit projections 75. If the first and second press-fit projections 73, 75 are press-fit into the press-fit portions 30 from above, an extending end part (upper end part) of the locking portion 77 bites into the outer wall surface 33. As shown in FIG. 5, an upward facing extending end surface 77U (upper end surface) of the locking portion 77 bites into the outer wall surface 33 from outside in the width direction. With the peg 70 and the housing 20 fixed, the extending end surface 77U bites into the inside of the outer wall surface 33 and contacts to support the inside of the outer wall surface from below. Thus, a downward displacement of the housing 20 with respect to the peg 70 can be prevented. As described above, since the peg 70 is fixed to the housing 20 at five different positions by the pair of first press-fit projections 73, the pair of second press-fit projections 75 and the locking portion 77, the peg 70 and the housing 20 are hardly relatively displaced by an external force.

The connector 10 in which the terminal fittings 90 and the pegs 70 are mounted in and on the housing 20 is mounted on the circuit board 100 by reflow soldering. Specifically, the rear end part of the board connecting portion 93 of each terminal fitting 90 and the fixing portion 85 of each peg 70 are placed on solder paste applied on the surface of the circuit board 100. Then, solder is melted in an unillustrated reflow furnace. Thereafter, by being cooled and solidified, the pegs 70 are soldered and fixed to the circuit board 100. In this way, the board connecting portion 93 of each terminal fitting 90 is soldered and connected to an electrically conductive part of the circuit board 100.

In a heating process in the reflow furnace, both end parts in the width direction of the housing 20 are relatively displaced downward with respect to the pegs 70. However, a downward relative displacement of each of the both end parts in the width direction of the housing 20 with respect to the peg 70 is suppressed by the locking action of the pair of first press-fit projections 73, the pair of second press-fit projections 75 and one locking portion 77. Therefore, in the connector 10 of this embodiment, the deformation of the housing 20 can be suppressed also under a high-temperature environment like the inside of the reflow furnace. In this way, the connection reliability of the connector 10 with the circuit board 100 can be ensured. By the above reflow process, the assembly and mounting of the connector 10 are completed.

The connector 10 of this embodiment is provided with the housing 20 and the pegs 70 made of metal. The housing 20 has a pair of the outer wall surfaces 33 located on the both end parts in the width direction. The press-fit portions 30 are formed on the outer wall surface 33. The peg 70 made of metal includes the fixing portion 85 to be fixed to the circuit board 100 and the plate-like portion 71 arranged to cover the outer wall surface 33. The plate-like portion 71 includes the pair of first press-fit projections 73 and the pair of second press-fit projections 75 projecting from the both front and rear outer side edges 71S. The peg 70 is fixed to the housing 20 by press-fitting the first press-fit projections 73 into the first press-fit recesses 39 and press-fitting the second press-fit projections 75 into the second press-fit recesses 53. The plate-like portion 71 includes the locking portion 77 located in a region separated in the front-rear direction from the both front and rear outer side edges 71S of the plate-like portion 71 and configured to bite into the outer wall surface 33. According to this configuration, the peg 70 is fixed to the housing 20 by the biting of the locking portion 77 into the outer wall surface 33 in addition to the press-fitting of the press-fit projections 72 into the press-fit portions 30. In particular, the first press-fit projections 73 and the second press-fit projections 75 of the peg 70 respectively bite into the first press-fit recesses 39 and the second press-fit recesses 53. Thus, the peg 70 is fixed to the housing 20 in the front-rear direction. Further, the peg 70 is fixed to the housing 20 in the vertical direction and the lateral direction by the locking portion 77 biting into the outer wall surface 33. In this way, the connection reliability of the connector 10 and the circuit board 100 can be ensured by reducing a displacement of the housing 20 of the connector 10 toward the circuit board 100 at the time of reflow.

The plate-like portion 71 includes the pair of front and rear first cut portions 81. The pair of first cut portions 81 extend in the vertical direction intersecting the circuit board 100 at the positions separated in the front-rear direction while penetrating through the plate-like portion 71 in the plate thickness direction. The plate-like portion 71 includes one second cut portion 83. The second cut portion 83 connects end parts of the pair of first cut portions 81 on a side distant from the circuit board 100 while penetrating through the plate-like portion 71 in the plate thickness direction. Out of the plate-like portion 71, the part cantilever-shaped by being defined by the pair of first cut portions 81 and the second cut portion 83 and inclined toward the outer wall surface 33 functions as the locking portion 77. According to this configuration, since the extending end surface 77U of the locking portion 77 bites into the outer wall surface 33 to support from the side of the circuit board 100, a displacement of the housing 20 toward the circuit board 100 at the time of reflow can be prevented.

The locking portion 77 has a rectangular shape with the second cut portion 83 serving as a long side. According to this configuration, as compared to the case where the locking portion 77 has a rectangular shape with the first cut portions 81 serving as long sides, a locking area (biting amount) of the extending end surface 77U of the locking portion 77 to the outer wall surface 33 can be increased, wherefore a displacement of the housing 20 in a direction approaching the circuit board 100 at the time of reflow can be effectively prevented.

The press-fit projection 72 includes the first and second press-fit projections 73, 75 arranged apart from each other in a length direction of the first cut portion 81 on each of the both front and rear side edges of the plate-like portion 71. A formation range of the first cut portion 81 is set only in a region between the first and second press-fit projections 73, 75. According to this configuration, the first and second press-fit projections 73, 75 are arranged at positions shifted in the length direction of the first cut portion 81 from a part of the plate-like portion 71 where a reduction in rigidity is concerned due to the formation of the first and second cut portions 81, 83. Therefore, the reliability of a fixing force by the press-fitting of the press-fit portion 30 and the press-fit projection 72 is excellent.

The plate-like portion 71 includes the pair of reinforcing portions 79 extending outward in the width direction from the both front and rear outer side edges 71S of the plate-like portion 71 between the first and second press-fit projections 73, 75. According to this configuration, parts of the plate-like portion 71 between the both front and rear outer side edges 71S and the first cut portions 81 are reinforced by the reinforcing portions 79. Thus, a reduction in the rigidity of the plate-like portion 71 due to the formation of the pair of first cut portions 81 and the second cut portion 83 can be prevented.

The outer wall surface 33 has the first restricting surfaces 61 facing the reinforcing portions 79 from the side of the fixing portion 85. According to this configuration, a relative movement of the peg 70 toward the fixing portion 85 with respect to the housing 20 can be restricted by locking the reinforcing portions 79 to the first restricting surfaces 61.

The outer wall surface 33 has the second restricting surfaces 63 for restricting outward relative displacements of the reinforcing portions 79 in the width direction with respect to the outer wall surface 33. According to this configuration, an outward relative movement of the peg 70 in the width direction with respect to the housing 20 can be restricted by locking the plate-like portion 71 to the second restricting surfaces 63.

### Other Embodiments of Present Disclosure

The present disclosure is not limited to the above described and illustrated embodiment, but is represented by claims. The present disclosure includes all changes in the scope of claims and in the meaning and scope of equivalents and includes also the following embodiments.
(1) The press-fit projection 72 of this embodiment may be, for example, composed of only one of the first and second press-fit projections 73, 75.
(2) Although the press-fit portion 30 of this embodiment includes the first press-fit recess 39, into which the first press-fit projection 73 is press-fit, and the second press-fit recess 53, into which the second press-fit projection 75 is press-fit, the shapes of the first and second press-fit recesses 39, 53 do not matter if the first and second press-fit recesses 39, 53 are so structured that the press-fit projection 72 is press-fittable thereinto.
(3) In this embodiment, the pair of first cut portions 81 may extend from positions below the upper ends of the second press-fit projections 75 to positions above the lower ends of the first press-fit projections 73. The pair of first cut portions 81 need not be parallel to each other.
(4) In this embodiment, the second cut portion 83 needs not connect the upper ends of the first cut portions 81 to each other. For example, the second cut portion 83 may connect parts below the upper ends of the first cut portions 81. In this case, a plate-like portion is formed with a pair of upper and lower locking portions with a second cut portion as a boundary.
(5) In this embodiment, the upper ends of the reinforcing portions 79 may be at positions higher than the lower ends of the first press-fit projections 73. The lower ends of the reinforcing portions 79 may be at positions lower than the upper ends of the second press-fit projections 75.
(6) The second restricting surface 63 of this embodiment may extend at an obtuse or acute angle to the first restricting surface 61.
(7) In this embodiment, the first restricting surface 61 needs not be provided in the press-fit portion 30. For example, a first restricting surface may extend to face the reinforcing portion 79 from the side of the fixing portion 85 from a position separated from the press-fit portion 30 on the outer wall surface 33.
(8) In this embodiment, the second restricting surface 63 needs not be provided in the press-fit portion 30. For example, a second restricting surface may extend to restrict an outward relative displacement of the reinforcing portion 79 in the width direction of the plate-like portion 71 from a position separated from the press-fit portion 30 on the outer wall surface 33.

### LIST OF REFERENCE NUMERALS

10 . . . connector
20 . . . housing
21 . . . wall portion
23 . . . receptacle
25 . . . upper wall
27 . . . lower wall
29 . . . side wall
30 . . . press-fit portion
31 . . . press-fit hole
33 . . . outer wall surface
39 . . . first press-fit recess
41 . . . first facing wall
43 . . . first side wall
45 . . . first bottom wall
47 . . . inclined surface
49 . . . first tapered portion
51 . . . second tapered portion
53 . . . second press-fit recess
55 . . . second facing wall
57 . . . second side wall
59 . . . second bottom wall
61 . . . first restricting surface
63 . . . second restricting surface
70 . . . peg
71 . . . plate-like portion
72 . . . press-fit projection
73 . . . first press-fit projection
75 . . . second press-fit projection
77 . . . locking portion
77U . . . extending end surface
79 . . . reinforcing portion
81 . . . first cut portion
83 . . . second cut portion
85 . . . fixing portion
90 . . . terminal fitting
91 . . . terminal connecting portion
93 . . . board connecting portion
95 . . . first bent portion
97 . . . protrusion
100 . . . circuit board
L . . . line segment

1. A connector, comprising:
a housing having a pair of outer wall surfaces located on both end parts in a width direction, the housing being formed with a press-fit portion on the outer wall surface; and
a peg made of metal and including a fixing portion to be fixed to a circuit board and a plate-like portion arranged to cover the outer wall surface, the peg being fixed to the housing by press-fitting a press-fit projection projecting from an outer edge part of the plate-like portion into the press-fit portion,
the plate-like portion including a locking portion located in a region separated from the outer edge part of the plate-like portion, the locking portion biting into the outer wall surface,
a part of the plate-like portion defined by a pair of front and rear first cut portions extending in a direction intersecting the circuit board and a second cut portion connecting end parts of the pair of first cut portions on a side distant from the circuit board functioning as the locking portion,
the press-fit projection including a first press-fit projection and a second press-fit projection arranged apart from each other in a length direction of the first cut portion on both front and rear side edges of the plate-like portion,
a formation range of the first cut portion being only a region between the first and second press-fit projections,
the plate-like portion including a pair of reinforcing portions extending outward in the width direction from the both front and rear side edges of the plate-like portion between the first and second press-fit projections.

2. The connector of claim 1, wherein:
the first cut portions and the second cut portion are formed to penetrate through the plate-like portion in a plate thickness direction, and
the locking portion is inclined toward the outer wall surface.

3. The connector of claim 2, wherein the locking portion has a rectangular shape with the second cut portion as a long side.

4. (canceled)

5. (canceled)

6. The connector of claim 1, wherein the outer wall surface has a first restricting surface facing the reinforcing portions from the fixing portion side.

7. The connector of claim 1, wherein the outer wall surface has a second restricting surface for restricting outward relative displacements of the reinforcing portions in the width direction with respect to the outer wall surface.
